(19) United States
(12) Patent Application Publication
(10) Pub. No.: US 2019/0247873 A1
(43) Pub. Date: Aug. 15, 2019

(54) ROTARY ATOMIZER

(71) Applicant: EISENMANN SE, Böblingen (DE)

(72) Inventor: Herbert Schulze, Aidlingen (DE)

(21) Appl. No.: 16/303,044

(22) PCT Filed: Apr. 25, 2017
(86) PCT No.: PCT/EP2017/059811

§ 371 Date: Nov. 19, 2018

(30) Foreign Application Priority Data
May 20, 2016 (DE) 10 2016 006 085.9

(51) Int. Cl. B05B 3/10; G01P 3/486; B05D 1/02

(52) U.S. Cl. CPC B05B 3/1085; B05D 1/02; G01P 3/486

(57) ABSTRACT

A rotary atomizer for atomizing a coating material for the coating of workpieces having a housing, a turbine wheel which is arranged in the housing and can be driven in two directions of rotation, a bell cup can be set in rotation by the turbine wheel about an axis of rotation and also a device for determining a rotational speed, wherein the device comprises an optical waveguide and a disc, which is indirectly or directly connected to the bell cup or the turbine wheel for rotation therewith and has an optically detectable structure, wherein the optical waveguide is designed for recording the optically detectable structure and for passing on the recorded structure as an optical signal in the housing. The optical waveguide has a first information channel and a second information channel, which are respectively designed for passing on an optical signal independently of one another.

### BACKGROUND OF THE INVENTION

### 1. Area of the Invention

The invention relates to a rotary atomizer for atomizing a coating material for coating workpieces, comprising a housing, a turbine wheel, which is arranged in the housing and is drivable in two rotational directions, a bell cup which can be set into rotation about an axis of rotation by the turbine wheel, and a device for ascertaining a rotational velocity, wherein the device comprises a rotating body and an optical waveguide.

### 2. Description of the Prior Art

Rotary atomizers of the type mentioned at the outset are used, for example, for the purpose of applying coating material such as lacquer in layers onto a vehicle body. The material provided for the coating is atomized for this purpose into ultrasmall particles.

During this atomization procedure, the particle size is dependent on the strength of the centrifugal force and thus also the rotational velocity: The higher the rotational velocity is, the more finely is the coating material atomized.

Efforts are therefore being made to operate the rotary atomizers at higher and higher rotational velocities, in order to achieve the finest possible atomization of the coating material.

Depending on the application, shaping air and/or an electrical high-voltage field for an electrostatic charge of the coating particles are used for forming the coating material stream leaving the rotating plate. Because the high voltage of the electrical field makes a signal transmission from the high-voltage region on electrical pathways difficult and susceptible to interference because of a required potential isolation, an optical system is used for the ascertainment of the speed and of the rotational direction. For example, a rotating body, for example, in the form of a disk, can be coupled in a rotationally-fixed manner to a turbine wheel. The rotating body can be provided with an optically detectable structure, which is convertible by means of an optical waveguide into an optical signal. The optical signal can be conducted out of the high-voltage region via the optical waveguide without separate potential isolation.

Because of the above-mentioned efforts toward higher speeds for better atomization, speeds well over 100,000 RPM have been attempted in the meantime, which has brought the signal processing components heretofore used to the limits of their performance. Signal relay and signal processing components which can also process the desired higher speeds and signal frequencies do exist. However, such components require a significantly higher investment of capital. Because of this fact, a compromise is sought between a clean recognition of the rotational direction and the signal processing of the rotational velocity signal at high rotational velocities. While the least possible number of structures, for example, light-dark contrasts, is desired at high rotational velocities, for good recognizability of a rotational direction, multiple such contrasts having intervals of different lengths are to be provided along a circular line.

### SUMMARY OF THE INVENTION

It is therefore an object of the invention to specify a rotary atomizer which enables a recognition of the rotational direction per se and an ascertainment of the speed even at high rotational velocities.

The object is achieved by a rotary atomizer as claimed in independent claim 1. Further embodiments of the invention are specified in the dependent claims.

The rotary atomizer according to the invention for atomizing a coating material for coating workpieces comprises a housing and a turbine wheel arranged in the housing. The turbine wheel is drivable in two rotational directions, for example, by means of compressed air. The rotary atomizer furthermore has a bell cup, which is rotatable about an axis of rotation and can be set into rotation by the turbine wheel.

The rotary atomizer has a device for ascertaining rotation-related items of information, for example, a rotational velocity. The device comprises a rotating body and an optical waveguide. The rotating body can be designed as a disk, for example, and is directly or indirectly connected in a rotationally-fixed manner to the bell cup or the turbine wheel, and therefore a rotation of the turbine wheel or the bell cup causes a corresponding rotation of the rotating body. The rotating body has an optically detectable structure. The optically detectable structure can be a region having modified reflection properties in relation to the remaining region of the surface of the rotating body, for example, a light-dark contrast, for example, a correspondingly colored surface. Alternatively or additionally, the structure can also be a spatial formation of the surface of the rotating body, for example, obliquely inclined surfaces or recesses. The optical waveguide can be provided with a suitable acquisition optical unit, for example, at its end oriented toward the disk, possibly also with a coupling optical unit, for example, a lens.

According to the invention, the optical waveguide has a first information channel and a second information channel. The first and the second information channel are each designed for the purpose of relaying an optical signal independently of one another.

An information channel is understood in the present case as an information channel which enables a relay of information uninfluenced by another information channel. The light can be, for example, a mixture of various light wavelengths or can be monochromatic. Various wavelength ranges, for example, visible light, infrared light, or also UV light are possible. For example, two information channels can be implemented via two separate optical waveguides, such as two glass or polymer fibers. Alternatively or additionally, for example, two different polarization directions or two different wavelengths within one glass fiber can represent two such information channels. Alternatively or additionally, time multiplexing can also take place in such a manner that a first signal is relayed during a first period of time and a second signal is relayed during a second period of time. The optical signal can be, for example, a sequence of intensity levels, which can be correlated with a speed, for example. Relay of the optical signals is understood in the present case to mean that an optical signal can be coupled into the optical waveguide and relayed.

In one preferred embodiment of the invention, it can be provided that the optical waveguide has two optical waveguide fibers for relaying the two optical signals. If two independent optical waveguides are used, the coupling location of the two optical signals can be different and therefore particularly good isolation of the two optical signals can be achieved.

In one refinement of the invention, it can be provided that the optically detectable structure forms at least one brightness contrast on the disk. This can be achieved, for example, by a suitable colored surface design of the disk. The first optically detectable structure can be arranged on a first circular line having a first radius of the disk and a second optically detectable structure can be arranged on a second circular line having a second radius of the disk. The first structure can be designed in this case such that during a rotation of the disk in relation to a stationary optical waveguide, a first optical signal having a first pulse frequency corresponding to the speed of the disk can be generated and the second structure can be designed such that during the rotation of the disk in relation to a stationary optical waveguide, a second pulse frequency can be generated, wherein the second pulse frequency is greater than the first pulse frequency. For example, the first pulse frequency can be at least twice as large as the second pulse frequency. The arrangement and design of the optical structures can be adapted in this case to the individual requirements.

The first and/or the second optically detectable structure preferably extend along the circular line. For example, the first and/or the second optical structure can be formed planar, for example, as a circular ring sector. The center point of the circular line is preferably the axis of rotation of the disk in this case. The extension along a circular line can preferably be designed in this case such that an optical detection of the structure, for example, a light-dark contrast, is possible.

The optical signals arising due to the optically detectable structure can have pulses which arise, for example, due to the detection of light-dark contrasts. In the case of a regular distribution of the light-dark contrasts along the circular line, one or more frequencies can also be associated with the pulses. The provision of two different pulse frequencies, for example, on two different information channels, enables an allocation of the items of information to be transmitted via the information channels.

In one exemplary embodiment, it can be provided that the first signal enables a rotational direction recognition. Therefore, in one embodiment, the first optical signal can be transmittable via a first information channel and the second optical signal can be transmittable via a second information channel. For example, a speed of the disk can be transmittable via the first information channel and a rotational direction and/or an acceleration of the disk can be transmittable via the second information channel. Therefore, at low speeds a recognition of the rotational direction and/or the acceleration can take place without problems by means of a corresponding finely resolved structure on the disk, while, for example, at higher speeds, a determination of the speed can take place using the same optical and/electronic acquisition means because of a lower resolution of the structure.

Two or more structures which can be optically acquired can thus be provided, for example, on the same disk, via which a low speed range can be covered at the required analysis accuracy via a first structure and a higher speed range can be covered at the required resolution via a second structure using the same optical and/or electronic acquisition means, for example, detectors and/or analysis electronics units.

For example, in one embodiment the two information channels can be differentiable by the polarization thereof. This can produce a corresponding allocation of the information channels, for example, by way of a polarization-selective surface of the structure. In this case, for example, only a part of the structure can reflect in a polarization-selective manner or different polarization directions can be provided for different region of the structure.

The object is also achieved by a method as claimed in claim 8 and by a facility as claimed in claim 9.

### BRIEF DESCRIPTION OF THE DRAWINGS

Exemplary embodiments of the invention are explained in greater detail hereafter on the basis of the drawings. In the figures:

FIG. 1 shows a first embodiment of the invention having two optical waveguides and a disk having an internal speed ascertainment structure;

FIG. 2 shows a partial view of the embodiment of FIG. 1;

FIG. 3 shows an illustration of the signals occurring in the first embodiment;

FIG. 4 shows a second embodiment of the invention having two optical waveguides having an external speed ascertainment structure on the disk;

FIG. 5 shows a partial view of FIG. 4;

FIG. 6 shows an illustration of the signals occurring in the second embodiment;

FIG. 7 shows a third embodiment of the invention having three optical waveguides having a rotational direction ascertainment structure arranged on the disk;

FIG. 8 shows a partial view of FIG. 7;

FIG. 9 shows an illustration of the signals occurring in the third embodiment;

FIG. 10 shows a fourth embodiment of the invention having an optical waveguide;

FIG. 11 shows a partial view of FIG. 10;

FIG. 12 shows an illustration of the signals occurring in the fourth embodiment;

FIG. 13 shows a fifth embodiment of the invention having an optical waveguide and a polarizing reflective structure on the disk;

FIG. 14 shows a partial view of FIG. 13; and

FIG. 15 shows an illustration of the signals occurring in the fifth embodiment.

### DESCRIPTION OF PREFERRED EXEMPLARY EMBODIMENTS

### 1. First Embodiment

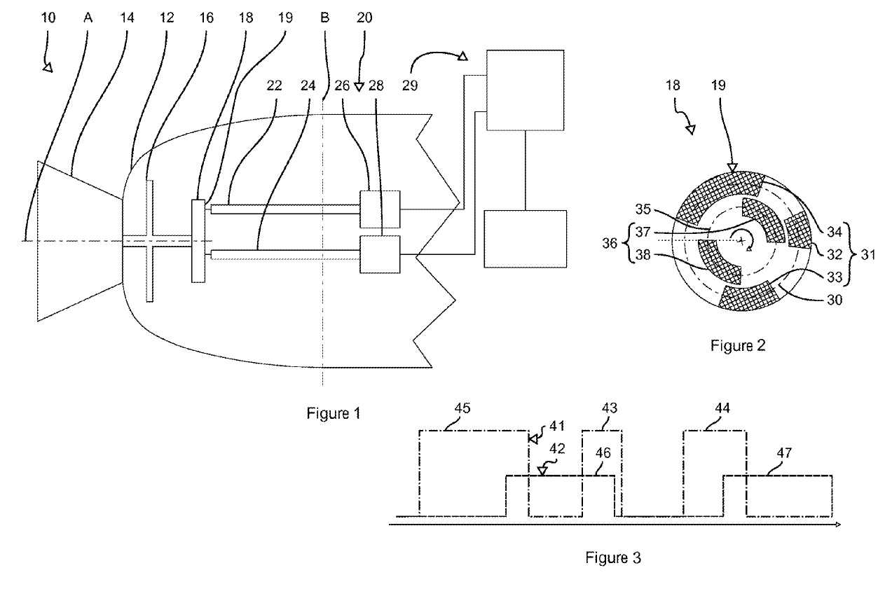

FIG. 1 shows a cross-sectional view of a first embodiment of a rotary atomizer 10 in a very schematic illustration and FIG. 2 shows a detail of the rotary atomizer 10 in a schematic top view. The illustration of the rotary atomizer 10 shows a housing 12, which encloses essential parts of the rotary atomizer 10. The rotary atomizer 10 can be, for example, part of a facility for coating vehicle bodies (not shown). A bell cup 14 for atomizing a coating material, for example, a lacquer, is schematically shown at the front side of the housing 12. The bell cup 14 is supported so it is rotatable about an axis of rotation A and is driven by a turbine (not shown) having a turbine wheel 16. The turbine wheel 16 is connected in a rotationally-fixed manner to a rotating body formed as a disk 18.

The disk 18 is only schematically shown in the cross-sectional view. The disk 18 is part of a device 20 for ascertaining rotation-related items of information, for example, a rotational velocity.

In this embodiment, a rotational velocity, an acceleration, and optionally a rotational direction are ascertainable, as will be explained in greater detail hereafter. The device 20 has, in addition to the disk 18, two optical waveguides 22, 24, two photodetectors 26, 28, and an associated analysis electronics unit 29. The optical waveguides 22, 24 are arranged in relation to the disk 18 in such a way that light reflected from the disk—specifically: from the surface 19 of the disk 18 which faces toward the optical waveguides 22, 24—can be coupled into the optical waveguides 22, 24. The optical waveguides 22, 24 can optionally be provided with a coupling optical unit, for example, corresponding lenses or the like, at the ends thereof facing toward the disk 18. The optical waveguides 22, 24 can be formed as monomodal or as multimodal fibers and can be produced, for example, from glass or from polymer.

Furthermore, a light source having oriented or diffuse light (not shown) can be arranged in the surroundings of the disk 18. The light source can illuminate the surface 19 of the disk 18.

In the embodiment shown in FIG. 1, a potential isolation, which extends in the present case between the photodetectors 26, 28 and the disk 18, is symbolically shown by means of a dashed line B. Specifically, this means that the potential isolation is overcome via the optical waveguides 22, 24 and the conversion from an optical signal to an electrical signal takes place outside the high-voltage region of the rotary atomizer 10.

In the present embodiment, the photodetectors 26, 28 are arranged inside the housing 12 of the rotary atomizer 10. Of course, the photodetectors 26, 28 and the associated analysis electronics unit 29 could also be arranged outside the housing 12.

FIG. 2 shows a schematic top view of the surface 19 of the disk 18. The disk 18 is embodied in the present case having a continuously closed surface 19 and is substantially circular. Of course, the surface 19 does not have to be continuous, but rather recesses or protrusions can be provided. A first structure 31 having a first reflection section 32, a second reflection section 33, and a third reflection section 34 is arranged on a first circular line 30 of the circular disk 18. A second structure 36 having a first reflection section 37 and a section reflection second 38 is arranged on a second circular line 35.

The individual reflection sections 32, 33, 34, 37, 38 are formed in this embodiment as sections of a respective circular ring—i.e., more or less as circular ring sectors—wherein the center point of the circular ring is arranged on the respective radius 30, 35. Of course, for example, the inner reflection sections 37, 38 can also be embodied as circular segments.

While the lengths of the reflection sections 37, 38 associated with the second circular line 35 along the respective circular arc and the regions located between the reflection sections 37, 38 are of equal length, the reflection sections 32-34 associated with the first circular line 30 have different lengths along the respective circular arc. The first reflection section 32 has the shortest length in this regard, the second reflection section 33 has a moderate length, and the third reflection section has the greatest length 34. The three different lengths of the three reflection sections 32-34 enable a determination of the rotational direction on the basis of the different sequence of the reflection sections 32-34 of different lengths.

The resulting optical signals are shown in FIG. 3 for a revolution clockwise, starting at the horizontal dotted line shown in FIG. 3. In FIG. 3, the optical signal 41 recorded via the first optical waveguide 22, which is arranged on a radius of the disk 18 located further outward, is shown as a schematic dot-dash line, the optical signal 42 recorded via the second optical waveguide 24, which is arranged on a radius of the disk 18 located further inward, is shown as a dashed line. The signals 41, 42 are plotted in FIG. 3 along a time axis as the abscissa, the associated ordinate and thus the level of the signals 41, 42 is not to scale and therefore does not represent a statement about possibly occurring signal strengths.

As can be inferred from FIG. 3, the first signal 41 has three signal pulses 43, 44, 45 having different lengths corresponding to the three reflection sections 32-34. The rotational direction can be concluded from the sequence of the pulses of different lengths. For a reliable recognition of the rotational direction, a sequence having three differentiable pulses of different lengths, for example, is selected as shown in this first embodiment in FIGS. 1 and 2. For the recognition of the rotational direction, in general a pulse sequence—consisting of pulse lengths and pulse intervals—should generally be provided which pulse sequence does not have mirror symmetry with respect to its chronological sequence. Corresponding to this, the pulse sequence could also consist of two pulses of different lengths having pulse intervals of different lengths between the first and the second pulse and between the second pulse and the first pulse which then follows in turn.

However, it is generally not possible using such a pulse sequence, at higher rotational frequencies, at which the signal processing comes to its limits, to relieve the signal processing by a reduction of the number of the signal pulses arising due to the disk 18 and the reflection sections located thereon.

This is enabled by the reflection sections 37, 38 located on the second circular line 35 and/or by the associated signal 42. As can be inferred from FIG. 3, the signal 42 has two pulses 46, 47 corresponding to the reflection sections 37, 38. The presence of only two pulses 46, 47 enables an ascertainment of the speed by means of the already provided signal acquisition and signal processing technology even at a higher speed of the bell cup 14. A further reduction of the number of pulses to be detected would be possible by the provision of a single reflection section, and therefore only a single pulse—induced by a dark-light contrast followed by a light-dark contrast—would be detected.

### 2. Second Embodiment

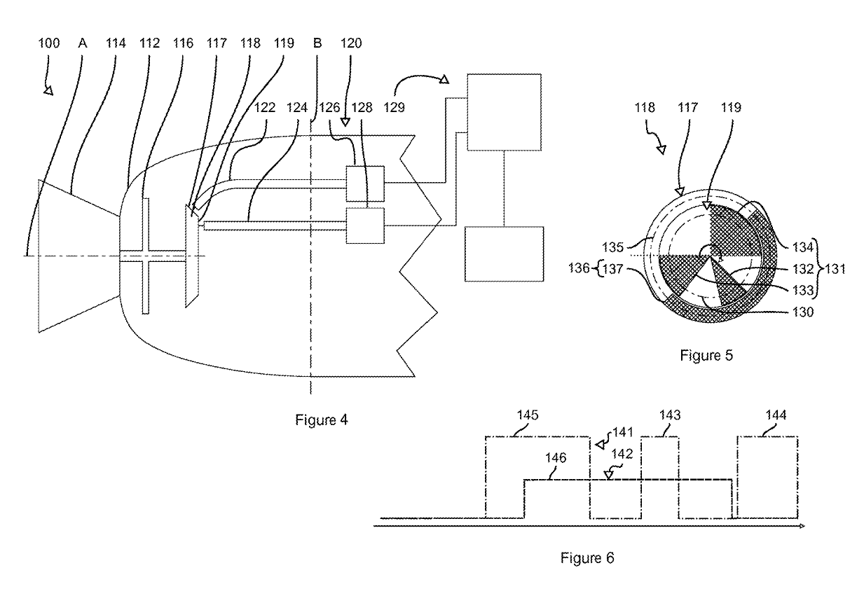

FIGS. 4-6 show a second embodiment of a rotary atomizer 100. Features which are identical or comparable with respect to the first embodiment are provided with reference signs to which 100 was added. To avoid repetitions, such features are not described again.

In contrast to the first embodiment, the device 120 for ascertaining rotation-related information of the rotary atomizer 100 of the second embodiment has, as shown in FIG. 4, a disk 118 having a first surface 119 comparable to the surface 19 of the rotary atomizer 10 of the first embodiment and a second surface 117, which is inclined in relation to the first surface 119. The second surface 117 is arranged in this embodiment at the outer edge of the disk 118 and thus enables a better signal transmission quality, since less scattered light of the first surface 119 is coupled into the second optical waveguide 122 and vice versa.

The allocation of the structures 131, 136 arranged on the first surface 119 and the second surface 117 as shown in FIG. 5 also differs from the first embodiment. In the second embodiment, a structure 136 having only one reflection section 137 is located on the outer second surface 117 on a first outer circular line 135. The reflection section 137 extends in the present case along a circular arc of the circular line 135 which makes up approximately half of the circular line 135, the other half of the circular line 135 is unoccupied.

A structure 131 having a total of three reflection sections 132-134 is arranged on a second inner circular line 130. As in the first embodiment, the reflection sections 132-134 differ with respect to the extension thereof along the circular line 130, and therefore an ascertainment of the rotational direction is possible as already described above. The reflection sections 132-134 of the structure 130 extend radially up to the center point of the surface 119, while the inner reflection sections 37, 38 of the first embodiment do not extend up to the center point. Depending on the individual conditions with respect to the reflectivity of the reflection sections, of the location, and of the direction of the illumination, the one or the other embodiment can be selected.

FIG. 6 of the second embodiment schematically shows the signals 141, 142 arising with the configuration of the disk 120 during a rotation about the axis of rotation A, beginning with the dotted horizontal line shown in FIG. 5. The signal 142, which arises in the event of a reflection of light at the reflection section 137, accordingly has only one pulse 146, which proportionally lasts half of the duration of a revolution. The optical signal 141 arising from the reflection sections 132-134 of the structure 131, in contrast, has, like also the signal 41, three pulses 143-145 having different pulse lengths, and therefore a rotational direction recognition is possible.

### 3. Third Embodiment

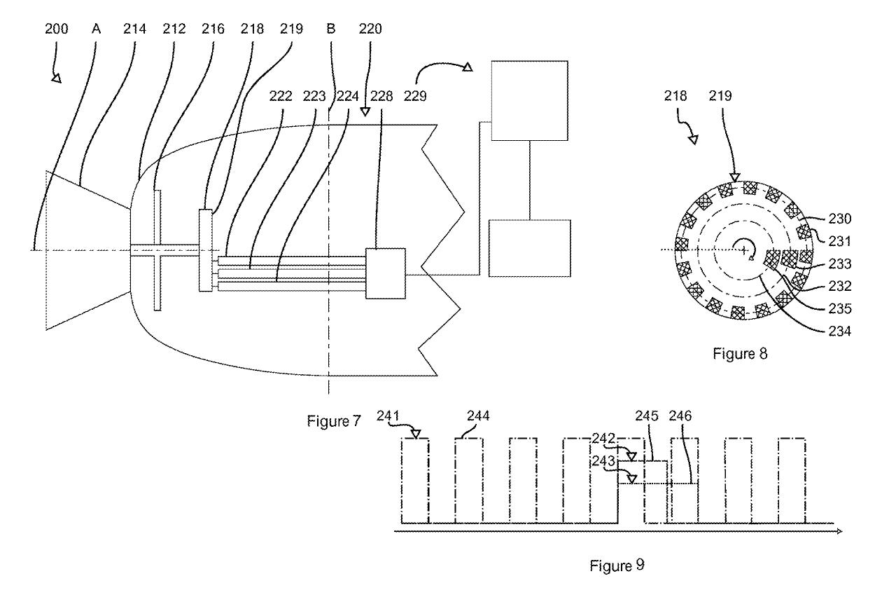

A rotary atomizer 300 is schematically shown in FIGS. 7-9 as the third embodiment. Features which are identical or comparable to those of the first or second embodiment are again identified with reference signs to which 100 or 200, respectively, was added, or vice versa.

The rotary atomizer 300 as shown in FIG. 7 has, in addition to the known features, a device 220 for ascertaining rotation-related items of information which, in contrast to the preceding embodiment, has three optical waveguides 222, 223, 224. Three photodetectors are accordingly provided, symbolically combined here in one unit 228.

Corresponding to the three optical waveguides 222, 223, 224, reflection sections are provided on three circular lines 230, 232, 234 having different radii on the surface 219 of the disk 218. In the present embodiment, 16 reflection sections 231, which are arranged equidistantly from one another along the circular line 230 and have a circular arc length which is equal to the distance to the next reflection section 231, are located on the outermost circular line 230. Only one single reflection section 233 is arranged on a circular line 232 located not as far outward, the circular arc length of which is somewhat greater than the circular arc length of the reflection sections 231 located farther outward and accordingly covers a greater rotational angle than the outer reflection section 231. A single reflection section 235 is also arranged on the innermost circular line 234, the circular arc length of which is again somewhat greater than the circular arc length of the reflection section 233 lying on the middle circular line 232 and covers approximately three times the rotational angle which an outer reflection section 231 covers.

FIG. 9 shows the three signals 241, 242, 243 arising due to this configuration during the rotation of the disk 218 clockwise, beginning with the horizontal dotted line shown in FIG. 8. The signal 141 displays 16 pulses 244 corresponding to the 16 reflection sections 231. The signal 242 of the reflection section 233 on the middle circular line comprises a pulse 245, which exceeds the length of the pulse 244 of the signal 241 in accordance with the circular arc length of the reflection section 233. The third signal 243 also accordingly has a single pulse 246, the length of which is in turn greater than that of the pulse 245 of the middle circular line 232. The rotational direction can accordingly be concluded in the example of FIG. 9 via the location of falling flanks of the pulses 245, 246. This would already be possible at lower speeds solely via the relative location of the falling flanks of the pulses 244, 245 of the signals 241, 242 associated with the outer circular line 230 and the middle circular line 232. At higher speeds, however, this is simpler using the signals 240, 243 comprising only one single pulse.

### 4. Fourth Embodiment

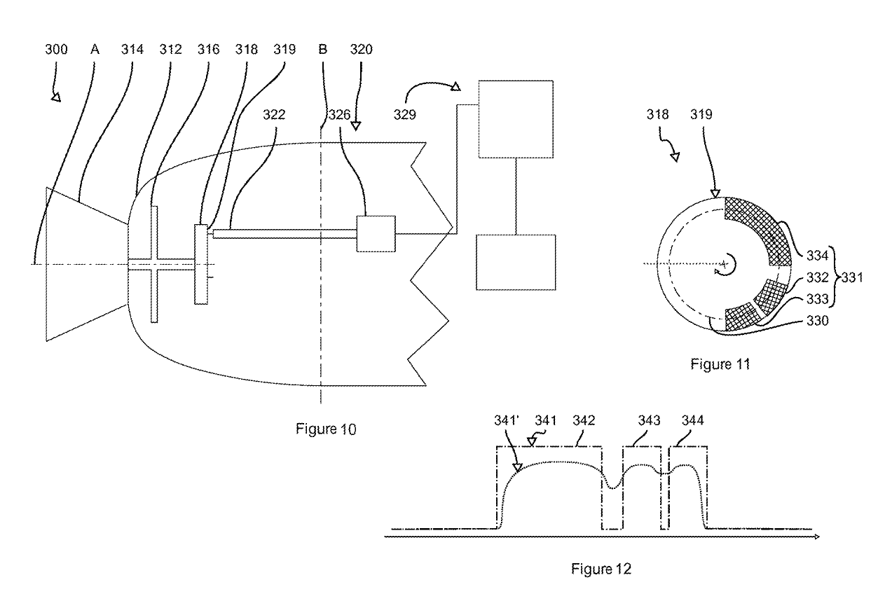

A rotary atomizer 300 is schematically shown in FIGS. 10-12 as the fourth embodiment. Features which are identical or comparable to those of the above-described embodiments are again identified with reference signs to which 100/200/300 was added.

In contrast to the first exemplary embodiment of FIGS. 1-3, the rotary atomizer 300 of the fourth embodiment only has one optical waveguide 322 and accordingly also only one photodetector 326. The surface 319 of the disk 318 of the device 320 for acquiring rotation-related items of information accordingly also has only one structure 331 on a circular line 330. The structure 331 has three reflection sections 332-334. The reflection sections 332, 333 are equal with respect to the circular arc length thereof, the reflection section 334 is significantly longer than the other two reflection sections 332, 333. Overall, the three reflection sections 332-334 are only arranged on one half of the circular line 330. The other half of the circular line 330 remains unoccupied. The intervals between the reflection sections 332-334 are not equidistant. Only one short circular arc interval exists between the two shorter reflection sections 332, 333, while the circular arc interval between the longer reflection section 334 and the shorter reflection section 132 is longer.

The signal 341 resulting during the rotation of the disk 318 about the axis of rotation A, beginning with the horizontal dotted line shown in FIG. 11, is shown in FIG. 12. It has a long pulse 342, which is followed by two shorter pulses 343, 344 of equal length. Because of the different intervals between the long pulse 342 and the short pulse 343, on the one hand, and the two shorter pulses 343, 344, on the other hand, the possibility of a rotational direction recognition exists at low rotational velocities. At higher rotational velocities, the finite flank slopes of the participating components become noticeable. This is symbolically shown by the signal 341′. The comparatively short pauses between the reflection sections 342, 343, 344 “smear together” and are detected as a single longer pulse, which is still sufficient for recognizing the rotational velocity. This time multiplexing therefore saves further components and nonetheless enables a recognition of the rotational velocity at high rotational velocities and the rotational direction at low rotational velocities.

### 5. Fifth Embodiment

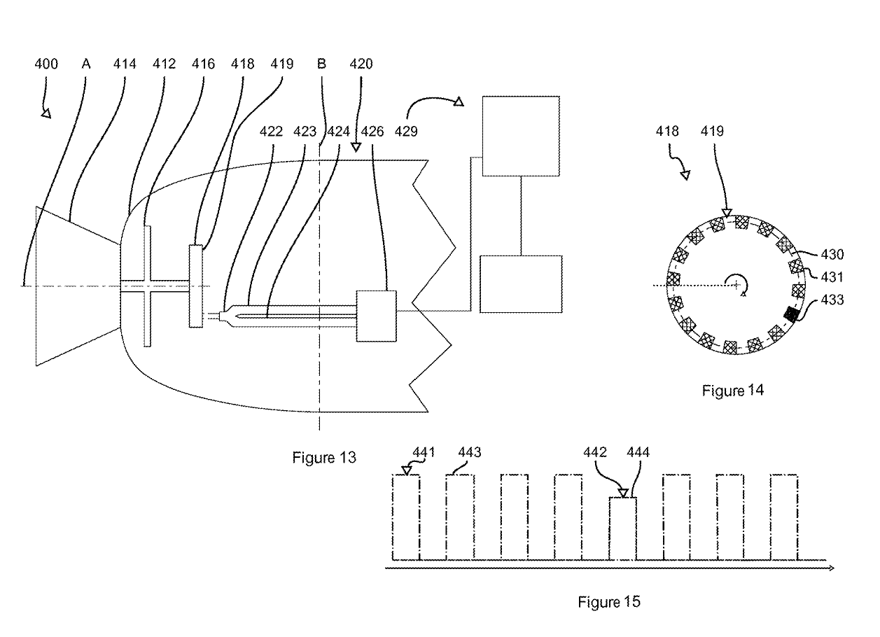

A rotary atomizer 400 is schematically shown in FIGS. 13-15 as the fifth embodiment. Features which are identical or comparable to those of the above-described embodiments are again identified with reference signs to which 100/200/300/400 was added.

The rotary atomizer 400 of the fifth embodiment, as schematically shown in FIG. 13, uses a polarization of the light reflected from the disk 418 to separate two different information channels. For this purpose, an optical waveguide 422 is provided as a device 420 for acquiring rotation-related items of information, which optical waveguide allocates the light coupled into the optical waveguide 422 with respect to its polarization onto two different optical waveguides 423, 424 by means of a splitter section. The light thus allocated is further processed in a photodetector 426, which generates an electrical signal for each of the different polarizations, and therefore a separate further processing of the different polarizations can be carried out.

The surface 419 of the disk 418 of the device 420 schematically shown in FIG. 14 has two different structures on a single circular line 430. A first structure 431 has a plurality of reflection sections 431, in the present embodiment, there are 15 reflection sections 431 arranged equidistantly on the circular line 430. The reflection sections 431 are nonspecific with respect to the polarization in this embodiment.

A second structure having a single reflection section 433 is incorporated in shape and location into the remaining reflection sections 431 but has a polarization-specific reflection behavior. This can mean, for example, that unpolarized incident light is reflected with a linear polarization. Other arrangements and combinations are also possible here, of course. For example, the polarization-specific reflection section 433 can also be arranged on a circular line having a different radius. This can result, for example, in an improvement of the crosstalk. Alternatively or additionally, the unpolarized reflecting sections 431 can also be made polarizing also in this exemplary embodiment. For example, a polarization direction perpendicular to the polarization direction of the one reflection section 431 can be provided.

FIG. 15 shows the signals 441, 442 arising for the above-described fifth embodiment. While the signal 441 associated with the plurality of reflection sections 431 has 15 pulses 443 corresponding to each reflection section 431, the signal associated with the polarizing reflection section 433 only has a single pulse 444, which more or less falls in the gap of the 15 other pulses.

Using conventional single-channel solutions, a technical limit is to be expected at approximately 100,000 RPM for the simultaneous recognition of rotational velocity and rotational direction. The reason is that from this rotational velocity, the transducer technology, for example, the photodetectors and downstream components, then operate in the high-frequency range with respect to the signal analysis. This would result in a high financial and apparatus expenditure.

With a simple reduction of the number of light-dark transitions on the rotating disk and thus a reduction of the number of pulses per individual revolution, however, this would have the result that a rotational direction recognition would no longer be possible and the acceleration behavior modulated on the basis of the recognized speed would be monitored less accurately.

Due to the allocation according to the invention of the function of an ascertainment of the speed at high speeds, at which the bell cup typically operates at constant velocity without larger accelerations, and the ascertainment of the acceleration and/or the rotational direction at lower speeds on 2 separate information channels, the maximum speed to be recognized can be shifted far upward.

The channel for recognizing the speed can be equipped with a separate reflector region, a separate optical waveguide, and a separate transducer and can have at minimum one light-dark transition. A reduction of the number of pulses per revolution to a minimum and a maximization of the speed for this channel are thus possible. Speed variations at this high speed range are nonetheless recognized with sufficient accuracy and can be recognized and processed by a controller.

One or more further channels can then be used, for example, as previously for recognizing the rotational direction at low speeds and for regulating the braking and acceleration procedures in the lower speed ranges.

For example, a first channel can be used for all functions, i.e., for example, for the recognition of the direction, a change of the speed, and the recognition of the speed per se in a speed range up to 70,000 RPM. A further channel can be used for a change, i.e., an acceleration, and for the recognition of the speed per se from 70,000 RPM.

In this way, the respective ranges of the rotating disk, the optical waveguide, and the transducer technology can be adapted and optimized to the respective area of responsibility. For example, different reflection elements, different optical waveguides, or different transducers can be used.

What is claimed is:

1. A rotary atomizer for atomizing a coating material for coating workpieces, comprising:
a turbine wheel, which is drivable in two rotational directions,
a bell cup which can be set into rotation about an axis of rotation by the turbine wheel, and
a device for ascertaining rotation-related items of information, wherein the device comprises a rotating body and an optical waveguide, wherein the rotating body is directly or indirectly connected in a rotationally fixed manner to the bell cup or the turbine wheel and has an optically detectable structure, wherein
the optical waveguide is designed to acquire the optically detectable structure and to relay the acquired structure as an optical signal, and further wherein
the optical waveguide has a first information channel and a second information channel, which are each designed to relay an optical signal independently of one another.

2. The rotary atomizer as claimed in claim 1, wherein the optical waveguide has two optical waveguide fibers for relaying optical signals from the first information channel and the second information channel.

3. The rotary atomizer as claimed in claim 1, wherein
the optically detectable structure forms a brightness contrast on the rotating body,
a first optically detectable structure is arranged on a first circular line of the rotating body and a second optically detectable structure is arranged on a second circular line of the rotating body, wherein
the first optically detectable structure on the first circular line generates a first optical signal having a first pulse frequency and on the second circular line generates a second optical signal having a second pulse frequency, wherein the first pulse frequency is greater than the second pulse frequency.

4. The rotary atomizer as claimed in claim 3, wherein the first pulse frequency is at least twice as large as the second pulse frequency.

5. The rotary atomizer as claimed in claim 3, wherein the first optical signal enables a rotational direction recognition and/or an acceleration recognition.

6. The rotary atomizer as claimed in claim 3, wherein wherein the first optical signal is transmittable via the first information channel and the second optical signal is transmittable via the second information channel.

7. The rotary atomizer as claimed in claim 1, wherein the first information channel and the second information channel are differentiable by the polarization thereof.

8. A method for coating objects by means of a rotary atomizer as claimed in claim 1.

9. A facility for coating objects such as vehicle bodies by means of a rotary atomizer as claimed in claim 1.
